(19) United States
(12) Patent Application Publication
(10) Pub. No.: US 2008/0123268 A1
(43) Pub. Date: May 29, 2008

(54) Television mount

(76) Inventor: Michael A. Taillefer, Mt. Clemens, MI (US)

Correspondence Address: HARNESS, DICKEY & PIERCE, P.L.C., P.O. BOX 828, BLOOMFIELD HILLS, MI, 48303, US

(21) Appl. No.: 11/606,367

(22) Filed: Nov. 29, 2006

(51) Int. Cl. G06F 1/16

(52) U.S. Cl. 361/681

(57) ABSTRACT

A mounting assembly for a flat panel display comprising a base panel, a bracket, and a cleat. The bracket connects the display to the base panel at approximately a right angle relative to the base panel. The cleat is in receipt of the base panel to secure the base panel at a support surface and to secure the display approximately perpendicular to the support surface.

### FIELD

The present disclosure relates to mounting assemblies. In particular, the present disclosure relates to mounting assemblies for a flat panel display.

### BACKGROUND

The statements in this section merely provide background information related to the present disclosure and may not constitute prior art.

Consumers often find it desirable to mount their flat panel display on a shelf or in a cabinet, such as an entertainment center cabinet or an armoire cabinet. In order to securely mount the display in a cabinet or on a shelf, current display assemblies often include a protruding tab or tongue at the front of the cabinet or shelf with the display positioned behind the tab or tongue. Such an arrangement is undesirable because it prevents the display from being positioned at the very front edge of the cabinet or shelf, thus resulting in an unsightly mounting arrangement. Further, such an arrangement makes it difficult to insert and remove the display from within the cabinet because the display must be raised over the tab during installation and removal. While current display assemblies are suitable for their intended uses, they are subject to improvement.

### SUMMARY

The present teachings provide for a mounting assembly for a flat panel display comprising a base panel, a bracket, and a cleat. The bracket connects the display to the base panel at approximately a right angle relative to the base panel. The cleat is in receipt of the base panel to secure the base panel at a support surface and to secure the display approximately perpendicular to the support surface.

The present teachings further provide for a mounting assembly for a flat panel display comprising a cleat and a bracket. The cleat has a base and a flange extending from the base. The bracket assembly is mounted to the display. The cleat slidably receives the bracket assembly beneath the flange to retain the display in an upright position.

The present teachings also provide for a method for supporting a flat panel display in an upright position upon a support surface comprising the following steps: fastening a cleat to the support surface; mounting a bracket assembly to a flat panel display; and sliding the bracket assembly into contact with the cleat to secure the flat panel display in an upright position on the support surface.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front perspective view of a flat panel display and a mounting assembly according to the present teachings;

FIG. 2 is a rear perspective view of the mounting assembly of FIG. 1;

FIG. 3 is a side view of the mounting assembly of FIG. 1, the mounting assembly seated within a cabinet;

FIG. 4 is a side view of the mounting assembly of FIG. 1 showing a cleat of the mounting assembly separated from the remaining portions of the mounting assembly;

FIG. 5A is a side view of the cleat in cooperation with a base panel of the mounting assembly;

FIG. 5B is a side view of the base panel separated from the cleat;

FIG. 6 is a rear view of an additional mounting assembly according to the present teachings;

FIG. 7 is a top view of the mounting assembly of FIG. 6; and

FIG. 8 is a rear perspective view of yet another mounting assembly according to the present teachings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

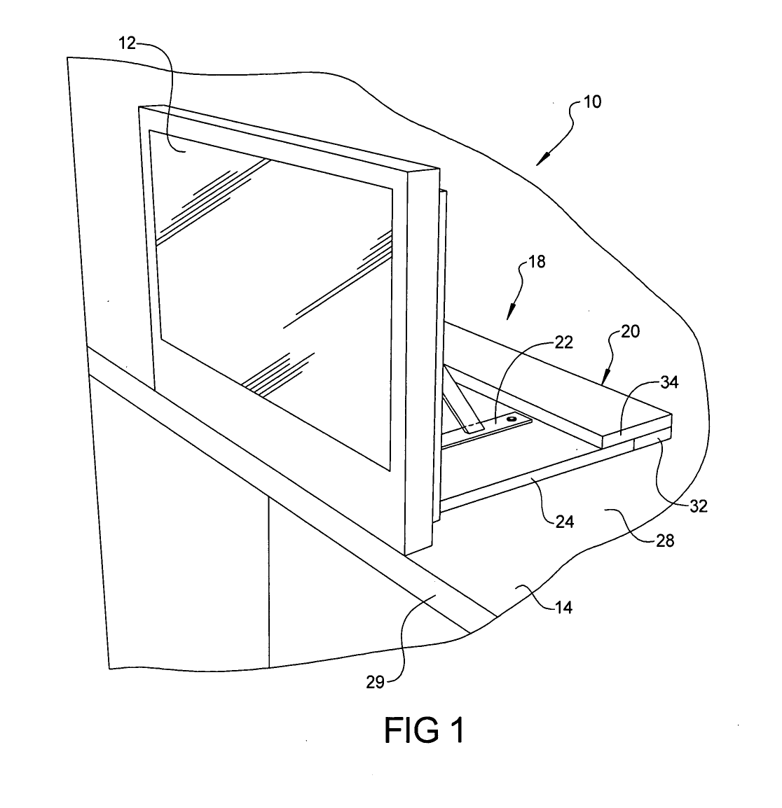

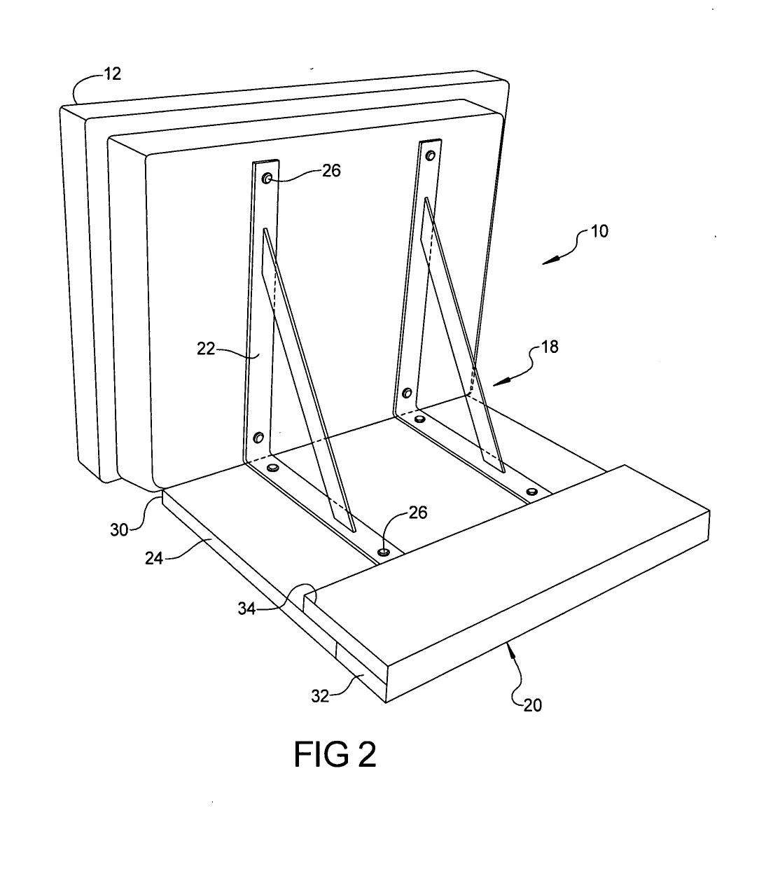

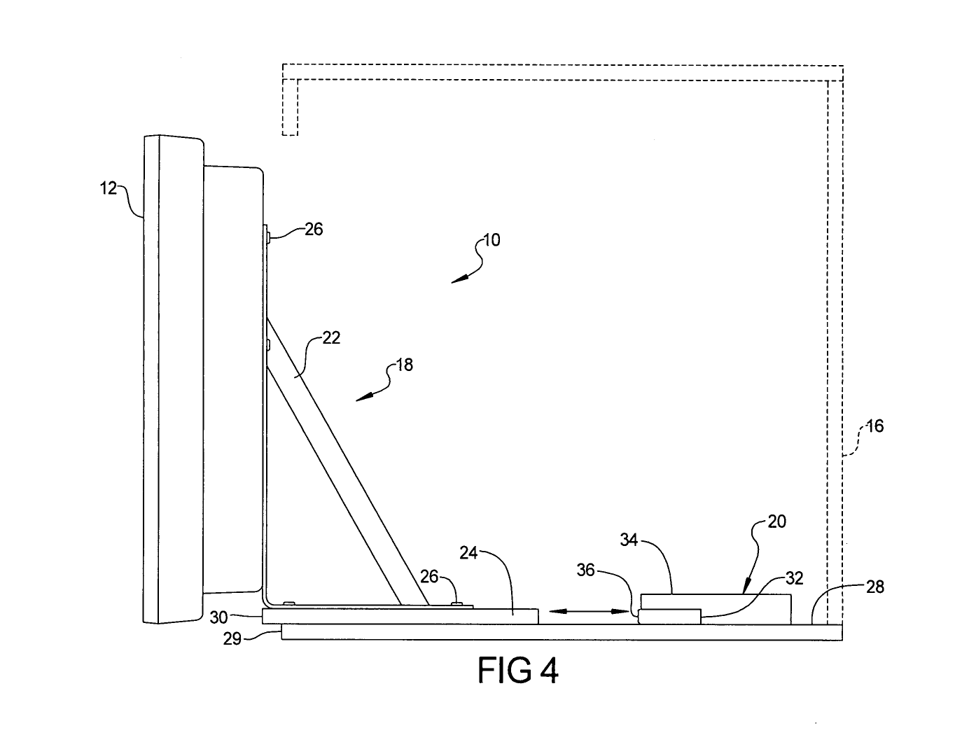

A mounting assembly according to the present teachings is illustrated in FIGS. 1-4 at reference numeral 10. The mounting assembly 10 can be used to mount or support a variety of different devices, such as a flat panel display 12. The assembly 10 can be used to mount the display 12 in a variety of different locations, such as on a shelf 14 (FIG. 1) or in an enclosed space, such as a cabinet 16.

The mounting assembly 10 can generally include a bracket assembly 18 and a cleat 20. The bracket assembly 18 can include a bracket 22 and a base panel 24. The bracket 22 can be any suitable mounting device to mount the display 12 to the base panel 24. For example, the bracket 22 can be an “L” bracket as illustrated in FIGS. 1-4. The base panel 24 can be any suitable device for supporting the bracket 22 and the display 12. For example, the base panel 24 can be a generally planar panel, as illustrated in the figures.

The bracket 22 can be mounted to both the display 12 and the base panel 24 using any suitable fastening device or method, such as fasteners 26. The bracket 22 can be mounted to a variety of suitable locations on both the base panel 24 and the display 12. For example, the bracket 22 can be aligned with preexisting mounts on the display 12 installed by the manufacturer of the display 12. The fastener 26 can then be inserted through an opening in the bracket 22 and into the preexisting mounts to secure the bracket 22 to the display 12. The display 12 can be mounted at a height such that the display 12 abuts or closely abuts a support surface 28 that the mounting assembly 10 is secured to.

The bracket 22 can be mounted at a variety of different locations on the base panel 24. For example, the bracket 22 can be mounted at or proximate to an edge of the base panel 24, such as an edge 30. Mounting the bracket 22 at the edge 30 allows the display 12 to be positioned offset from the base panel 24 so that the display 12 can abut or closely abut the support surface 28. Mounting the bracket 22 at the edge 30 further permits the display 12 to be flush or nearly flush with a front face 29 of the article that the mounting assembly is seated in or on, such as the shelf 14 or the cabinet 16.

The cleat 20 can be any suitable retention device for retaining the display 12 in an upright position. For example, as illustrated in FIGS. 1-4, the cleat 20 can include a base portion 32 and a flange portion 34. The base portion 32 can be mounted to the support surface 28 using any suitable fastening device or method. The base portion 32 can be mounted directly to the support surface 28, as illustrated. An intermediary plate or panel can be positioned between the base portion 32 and the support surface 28. When the cleat 20 is mounted to the support surface 28, the flange 34 defines a slot 36 between the flange 34 and the support surface 28. The slot 36 is sized to receive the base panel 24.

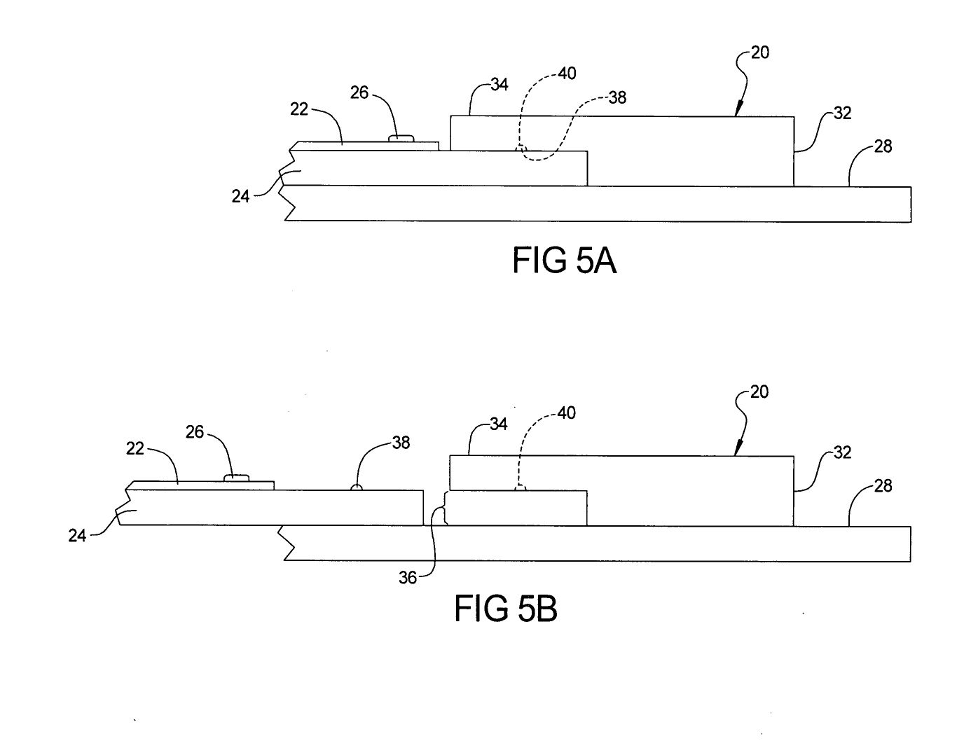

The base panel 24 and/or the cleat 20 can include a retention device to enhance the retention of the base panel 24 in the slot 36. The retention device can be any suitable retention device for securing the base panel 24 within the slot 36. For example, as illustrated in FIGS. 5A and 5B, the retention device can include a protruding detail 38 and a recessed detail 40. The protruding detail 38 can be positioned on the base panel 24 and the recessed detail 40 can be positioned on a surface of the flange 34 facing the slot 36, or vice versa. The protruding detail 38 and the recessed detail 40 can be positioned so that they are in alignment with each other when the base panel 24 is seated within the slot 36. When the details 38 and 40 are in alignment, the protruding detail 38 can be seated within the recessed detail 40 to enhance retention of the base panel 24 within the slot 36.

Assembly and installation of the mounting assembly will now be described. The order in which the different assembly and installation steps are set forth herein is for exemplary purposes only.

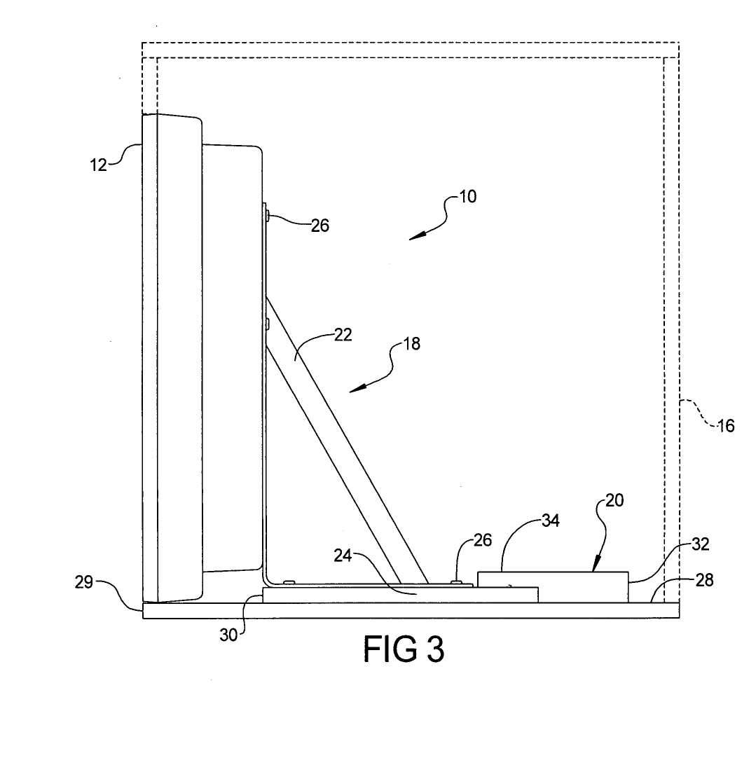

The cleat 20 can be secured to the support surface 28 of the area or article where the mounting assembly is to be installed, such as on the shelf 14 (FIG. 1) or within the cabinet 16 (FIG. 3). The cleat 20 can be secured to the support surface 28 by mounting the base portion 32 to the support surface 28 using any suitable fastening device. The cleat 20 can be positioned on the support surface 28 at a distance from the front face 29 such that a viewing side of the display 12 is flush with the front face 29 of the shelf 14 or the cabinet 16 when the display 12 is in the installed position of FIGS. 1 and 3. If it is desirable to position the display 12 offset from the front face 29, then the cleat 20 can be mounted further from the front face 29.

The bracket 22 can be mounted to the base panel 24 using the fasteners 26. The bracket 22 can be mounted at or proximate to the edge 30 of the base 24 so that the display 12 is mounted beyond the edge 30 of the base panel 24.

The display 12 can be mounted to the bracket 22 using the fasteners 26. The fasteners 26 can be inserted through apertures in the bracket 22 to engage mounts in a rear of the display 12. The display 12 can be mounted on the bracket 22 at a height such that the display 12 abuts, or nearly abuts, the support surface 28, as illustrated in FIG. 1 after installation is complete. The height of the display 12 can be adjusted by mounting the display 12 at different vertical positions on the bracket 22, which can be accommodated by providing the bracket 22 with a plurality of vertical mounting apertures, and/or by mounting the bracket 22 to different vertical positions on the display 12, which can be accommodated by providing the display 12 with different vertical mounts.

The base panel 24 can be inserted within the slot 36 defined by the cleat 20 to retain the display 12 in the upright position as illustrated and to retain the display 12 at the front face 29 of the shelf 14 or the cabinet 16. To further retain the base panel 24 in the slot 36, the base panel 24 can include the protruding detail 38 and the flange 34 can include the recessed detail 40, or vice versa. When the base panel 24 is inserted within the slot 36 the protruding detail 38 is received by the recessed detail 40 to further secure the base panel 24 within the slot 36.

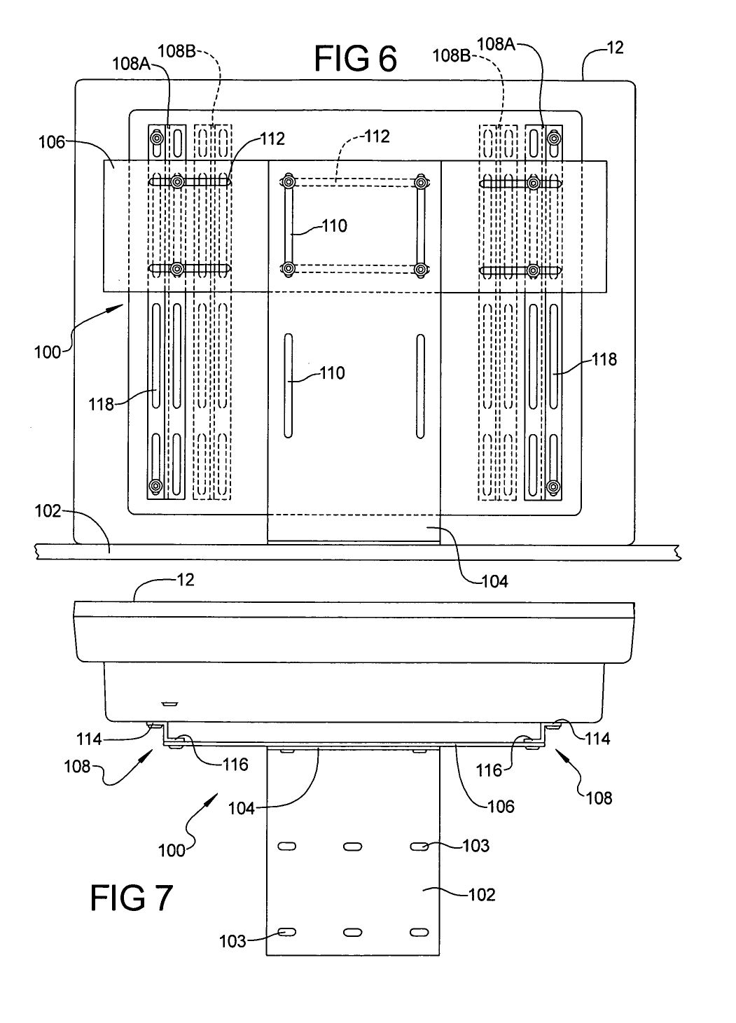

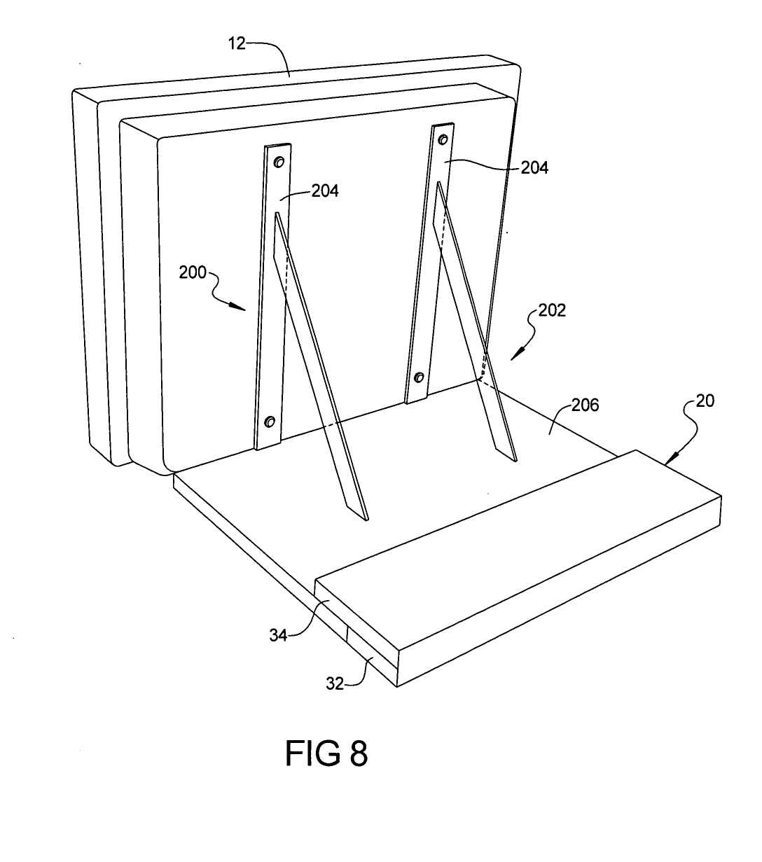

With additional reference to FIGS. 6 and 7, an additional bracket assembly according to the present teachings for use with the mounting assembly 10 is illustrated at reference numeral 100. The bracket assembly 100 can include a horizontal base 102, a vertical support 104, a horizontal plate 106, and one or more mounting strips 108.

The horizontal base 102 can be any suitable base for supporting the display 12. The horizontal base 102 can be a generally planar base. The horizontal base 102 can be mounted to the base panel 24 or, for example, it can be a stand-alone base that can be directly received by the cleat 20. The horizontal base 102 can include one or more mounting apertures 103. The mounting apertures 103 can receive a fastener to, for example, secure the horizontal base 102 to the base panel 24 or secure the horizontal base 102 to the support surface 28. The mounting apertures 103 can also be used to engage a suitable fastening device of the cleat 20 to retain cooperation between the cleat 20 and bracket assembly 100.

The vertical support 104 can be secured to the horizontal base 102 or can be unitary with the horizontal base 102. The vertical support 104 can include one or more through holes or slots 110 for receiving a fastener. The slots 110 can be positioned at a variety of different locations on the vertical support 104, such as at the outer edges of the vertical support 104.

The horizontal plate 106 can be an elongated, generally planar plate. The plate 106 can include a variety of horizontal slots 112. The slots 112 can receive a suitable fastening device. The slots 112 can be positioned at any suitable location on the plate 106, such as along the upper and lower edges of the plate 106.

The mounting strips 108 can be elongated strips each having a first portion 114 and a second portion 116. The first portion 114 can be offset from the second portion 116, as illustrated in FIG. 7. The first portion 114 and the second portion 116 of each of the mounting strips 108 can include one or more elongated slots 118. The slots 118 can receive a suitable fastening device.

The mounting strips 108 can be mounted to opposite sides of a rear surface of the display 12. The mounting strips 108 can be mounted to preexisting mounts or holes in the rear of the display. Each of the mounting strips 108 can be mounted using one or more fasteners extending through one of the slots 118 of the first portion 114. With the first portion 114 secured to the rear of the display 12, the second portion 116 is offset from the rear of the display 12, as illustrated in FIG. 7. The distance between the mounting strips 108 may vary depending on the location of the mounts in the rear of the display 12. For example, as illustrated in FIG. 6, mounting strips 108A are mounted to display mounts of the display 12 that are at the outer edges of the display 12. If the mounts of the display 12 are further inboard, the mounting strips 108 can be moved to the position of mounting strips 108B. The length of the horizontal slots 112 is sufficient to accommodate a fastener for engaging the mounting strips 108 at a variety of different locations on the display 12.

The horizontal plate 106 can be mounted to the vertical supports 104 using a suitable fastener. The fastener can engage any of the slots 110 at any point along the length of the slots 110. The fastener can also engage the horizontal slots 112 at any point along the length of the horizontal slots to mount the vertical support 104 to the horizontal plate 106. The height of the horizontal plate 106 can be adjusted based on the point in the slots 110 where the horizontal plate 106 is mounted.

The horizontal plate 106 can be mounted to the mounting strips 108 using fasteners that engage both the horizontal slots 112 of the horizontal plate 106 and the elongated slots 118 of the second portion 116 of the mounting strips 108. The height at which the panel 12 is mounted can be adjusted by mounting the horizontal plate 106 to a higher or lower location on the mounting strips 108, which can be accommodated by the elongated slots 118.

With additional reference to FIG. 8, an additional bracket assembly according to the present teachings is illustrated at reference numeral 200. The bracket assembly 200 is similar to the assembly 18. The only substantial difference between the bracket assembly 200 and the bracket assembly 18 is that the bracket assembly 200 includes an integrated bracket 202, which takes the place of the bracket 22 and the base panel 24. Specifically, the bracket assembly 200 includes vertical supports 204 that are integrated with a base 206 that is received by the cleat 20.

The cleat 20 can be made of any suitable material, such as a metal, wood, and a polymeric material.

The bracket assemblies 18, 100, and 200 can also be made of any suitable material, such as a metal, wood, or polymeric material.

What is claimed is:

1. A mounting assembly for a flat panel display comprising:
a base panel;
a bracket connecting the display to said base panel at approximately a right angle relative to said base panel; and
a cleat in receipt of said base panel to secure said base panel at a support surface and to secure the display approximately perpendicular to the support surface.

2. The mounting assembly of claim 1, wherein said base panel is integrated with said bracket.

3. The mounting assembly of claim 1, wherein said base panel and said cleat comprise a retention device to secure said base panel in cooperation with said cleat.

4. The mounting assembly of claim 1, wherein said base panel comprises a protruding detail and said cleat comprises a recessed detail, said protruding detail is received by said recessed detail when said cleat is in receipt of said base panel to secure said base panel in cooperation with said cleat.

5. The mounting assembly of claim 1, wherein the support surface is a cabinet support surface and the cleat is mounted to the support surface at a position to mount the display at a front face of the cabinet.

6. The mounting assembly of claim 1, wherein said cleat comprises a base portion and a flange, said base portion and said flange define a slot between said flange, said base portion, and the support surface; and
wherein said base panel is seated in said slot.

7. The mounting assembly of claim 1, wherein said bracket is an “L” bracket.

8. The mounting assembly of claim 1, wherein the display is supported beyond an outer edge of the base panel.

9. A mounting assembly for a flat panel display comprising:
a cleat having a base and a flange extending from said base; and
a bracket assembly mounted to the display;
wherein said cleat slidably receives said bracket assembly beneath said flange to retain the display in an upright position.

10. The mounting assembly of claim 9, wherein said bracket assembly comprises a horizontal base, a vertical support, a horizontal plate, and at least one mounting strip;
wherein said mounting strip is mounted to the display; and
wherein said horizontal plate connects said mounting strip to said vertical support.

11. The mounting assembly of claim 10, wherein said vertical support is orientated about ninety degrees relative to said horizontal base.

12. The mounting assembly of claim 10, wherein said cleat receives said horizontal base.

13. The mounting assembly of claim 10, wherein said bracket assembly further comprises a base panel;
wherein said horizontal plate is mounted to said base panel and said base panel is received by said cleat.

14. The mounting assembly of claim 10, wherein said vertical support, said horizontal plate, and said mounting strip each comprise at least one mounting slot.

15. The mounting assembly of claim 10, wherein said cleat comprises a base portion and a flange that define a slot;
wherein said slot slidably receives said bracket assembly.

16. The mounting assembly of claim 10, wherein a height at which the display is mounted is adjusted by varying at least one of a vertical position at which said horizontal plate is mounted to said mounting strip and a vertical position at which said horizontal plate is mounted to said vertical support.

17. The mounting assembly of claim 9, wherein said cleat is mounted to a support surface and the display is positioned at a front face of the support surface.

18. A method for supporting a flat panel display in an upright position upon a support surface comprising:
fastening a cleat to the support surface;
mounting a bracket assembly to a flat panel display; and
sliding the bracket assembly into contact with the cleat to secure the flat panel display in an upright position on the support surface.

19. The method of claim 18, further comprising adjusting a vertical position of the display on said bracket assembly to position the display at least closely adjacent to the support surface.

20. The method of claim 18, further comprising positioning the display such that is at least closely adjacent to a front face of the support surface.
